(19) United States
(12) Patent Application Publication
(10) Pub. No.: US 2023/0344818 A1
(43) Pub. Date: Oct. 26, 2023

(54) SYSTEMS AND METHODS FOR SECURELY ESTABLISHING TRUSTED DEVICE BONDING

(71) Applicant: Meta Platforms Technologies, LLC, Menlo Park, CA (US)

(72) Inventors: Erin Watson, San Francisco, CA (US); Ahmed Mohamed Eid Amin, Santa Clara, CA (US); Oleksandr Kotliarskyi, Seattle, WA (US); Sebastian Lange, Seattle, WA (US); Shaheen Ashok Gandhi, Seattle, WA (US)

(21) Appl. No.: 16/201,910

(22) Filed: Nov. 27, 2018

(51) Int. Cl. H04L 29/06; H04W 76/15; H04W 12/00; H04W 12/06; H04W 12/04

(52) U.S. Cl. CPC H04L 63/0823; H04W 76/15; H04W 12/003; H04W 12/0609; H04W 12/04031; H04L 63/062

(57) ABSTRACT

In one embodiment, a computing device establishes a secure connection with user equipment. The computing device receives a credential for a remote user account and connects to a remote user account based on the credential. The computing device generates a bonding key based on information associated with the remote user account and sends the bonding key to the user equipment through the secure connection for storage by the user equipment. Subsequent to the sending of the bonding key, proof of possession of the bonding key is required for establishing a trusted connection with the user equipment.

### TECHNICAL FIELD

This disclosure generally relates to systems and methods for securely establishing trusted bonding between devices.

### BACKGROUND

Wireless interconnectivity between peer-to-peer electronic devices has become ubiquitous. For example, mobile phones may wirelessly communicate with earphones, speakers, security cameras, thermostats, door locks, sensors, among others. Similarly, several Internet-of-Things (IoT) devices may also wirelessly communicate with each other. Such communications are typically established over short-range wireless technology, such as Bluetooth Low Energy® (BLE), ZigBee®, etc.

Existing short-range wireless communication protocols have several shortcomings. Using BLE as an example, even though BLE has a security protocol, it has been proven to be insufficiently secure as it is vulnerable to man-in-the-middle attacks. As another example, Bluetooth® short-range wireless technology's security protocol requires a user to enter passcodes from one device (e.g., mobile phone) in order to bond to another device, which introduces friction in the initial setup experience. Moreover, after two devices have been bonded, the bonding is at the device level. The implication of this is that, if the user wishes to use a different device to connect to one of the previously bonded devices, the user would have to go through the setup process again to establish a new bonding.

### SUMMARY OF PARTICULAR EMBODIMENTS

Embodiments described herein pertain to an improved communication protocol for creating secure, trusted connections between a computing device and user equipment. The computing device may take the form of a mobile phone, tablet, a personal computer, or any other computing device that provides a suitable user interface through which the user may interact with a software application for establishing the desired trusted connection with user equipment. Examples of user equipment may include, among other possibilities, virtual-reality or augmented-reality headsets, earphones, vehicles, speakers, security cameras, thermostats, door locks, sensors, etc.

Particular embodiments provide a secure and efficient protocol for creating a trusted connection between a computing device and user equipment. The computing device and the user equipment may establish a secure communication session through the exchange of encryption keys. During this exchange, the user equipment may send the computing device a device certificate that may be used to prove the authenticity of the user equipment (e.g., proving that the user equipment is an authentic, untampered virtual reality headset manufactured by a particular company, for example). The device certificate may be generated (e.g., by a trusted certificate authority) for the user equipment at the time of manufacture and may be unique and/or exclusive to each user equipment. When establishing a communication session with the user equipment, the computing device may receive the device certificate from the user equipment and validate the device certificate to ensure that the user equipment is trustworthy. In particular embodiments, the computing device may validate the device certificate by sending it to a server, which in turn may communicate with the certificate authority to verify the trustworthiness of the device certificate. In addition, the computing device may receive from the user equipment a signature, which may be a signed challenge generated by the user equipment by encrypting a challenge (e.g., randomly-generated data) received from the computing device using a private key that was provided to and stored by the user equipment at the time of manufacture (referred to as the “device private key”). Using the corresponding public key (e.g., which may be included in the device certificate), the computing device may verify the signature (e.g., decrypting the signature and verifying that the signed challenge matches the original challenge sent by the computing device). In doing so, the computing device can verify that the user equipment is trustworthy.

In particular embodiments, validation of the device certificate may occur for each data transmission or a subset of data transmissions so that, throughout the communication, the computing device can ensure that it is communicating with a trusted user equipment. While the device certificate may be transmitted each time to the computing device, doing so may incur significant transmission delays due to the size of the device certificate. Particular embodiments address this problem by having the computing device store the device certificate and transmit a fingerprint of the device certificate, which is significantly smaller in size relative to the device certificate, to the user equipment to verify that both parties continue to have the same certificate.

In further embodiments, bonding between the computing device and the user equipment may be based on information associated with a remote user account of the user. Through the computing device, the user may log into the remote user account and obtain a bonding key, which may be generated from information on the remote user account. The bonding key may be sent through the secure communication channel to the user equipment, where the bonding key is stored. In subsequent communications, in order to establish a trusted connection, the user equipment may require the computing device to prove that it has the same bonding key as the one stored by the user equipment. Thereafter, if the user wishes to use a different computing device to communicate with the user equipment, the user may simply log into his remote user account via the new computing device to obtaining the bonding key to establish a trusted connection with the user equipment, without having to undergo the setup process once again.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIGS. 1A-1B provide an example of a traditional bonding procedure.

FIG. 2A provides an example of an initial setup scenario in particular embodiments of the bonding procedure described herein.

FIG. 2B provides an example of a post-setup scenario in accordance with particular embodiments, where the user is connecting to the user equipment using the same computing device.

FIG. 2C provides an example of another post-setup scenario in accordance with particular embodiments, where the same user is connecting to the equipment using a different computing device.

FIG. 2D provides an example of another post-setup scenario in accordance with particular embodiments, where a different user is trying to connect to the equipment.

FIG. 3A provides a timing diagram of an initial setup scenario in particular embodiments of the bonding procedure described herein.

FIG. 3B provides a timing diagram of a post-setup scenario in particular embodiments.

FIG. 4A illustrates an example method for bonding a computing device and user equipment, in accordance with particular embodiments.

FIG. 4B illustrates an example method for establishing a trusted connection with user equipment that has been bonded.

FIG. 5 illustrates an example network environment associated with a social-networking system in particular embodiments.

FIG. 6 illustrates an example computer system in particular embodiments.

### DESCRIPTION OF EXAMPLE EMBODIMENTS

Particular embodiments described herein pertain to an improved communication protocol used for securely establishing a trusted connection between devices. Ever increasingly, electronic devices (e.g., smart mobile devices, tablets, printers, speakers, televisions, vehicles, etc.) are being designed to communicate with each other wirelessly. The wireless medium for communication may be based on short-range wireless technologies, such as Bluetooth® short-range wireless technology and Wi-Fi™. While wireless communication provides numerous benefits and endless useful applications, one shortcoming of wireless communication is that it is more vulnerable to security breaches. For example, data that is communicated through radio waves may be intercepted, and man-in-the-middle attacks may falsify communication. Thus, short-range wireless protocols, such as BLE, have various security features. Unfortunately, it has been shown that such security features are still vulnerable to attacks and the protocol for establishing secure communication is overly onerous for certain applications.

In one example, electronic equipment that lacks a readily-accessible user interface may rely on another computing device with a readily-accessible user interface to serve as the medium through which the user may configure and/or interact with the equipment. For example, a “smart” security camera, door lock, printer, or lightbulb may lack a display for outputting information to the user and also lack an input device for allowing the user to input information. Other types of electronic equipment may have the means for inputting and outputting information, but the design of such means may be overly cumbersome or creates too much friction for purposes of equipment configuration. For example, although head-mounted displays used for virtual-reality applications have means for outputting information (e.g., via the display screen in the head-mounted display) and means for receiving user input (e.g., via the hand controllers), the controllers may be designed for detecting gestures and not for fine motor input, such as inputting letters and numerals (e.g., typing may require the use of a virtual pointer, controlled by the controllers, to point to a virtual keyboard displayed through the head-mounted display). In addition, a virtual-reality head-mounted display is designed to occlude the physical world from the user's vision, which makes it difficult for the user to simultaneously see the physical world and the user interface being displayed through the head-mounted display. This design feature of the virtual-reality equipment, unfortunately, makes tasks like entering a credit card number or Wi-Fi™ password cumbersome, as the user would need to take on and off the head-mounted display or try to remember the information needed.

To provide readily-accessible or user-friendly user interfaces for user equipment like the ones described above, particular embodiments utilize a computing device (e.g., a smartphone, tablet, laptop, desktop, etc.) to communicate with the equipment. In particular embodiments, the computing device may be provided with a companion application (CA) that is configured to provide the desired user interface for the associated user equipment. In particular embodiments, the companion application may communicate with a companion server (CS) on the user equipment. The companion server may be implemented as a system service running on the user equipment (e.g., such as a virtual-reality head-mounted display). Through the companion application and the companion server, the user may perform tasks such as setting up and configuring the user equipment through the user's computing device.

In particular embodiments, the CA on the computing device and the CS on the user equipment may communicate via short-range wireless technology, such as BLE. On bootup, the CS may begin advertising BLE packets to announce its presence. The advertising packets may contain a service UUID (Universally Unique Identifier), a manufacturer code and manufacturer-specific data. The CA may scan for such BLE advertising packets, filtering by service UUID and/or manufacturer data to identify the desired user equipment (e.g., a particular type or model of virtual-reality head-mounted display). When the user selects an available user equipment via CA, a BLE communication channel is established. In particular embodiments, the Generic Attributes Profile (GATT) may define how data is communicated between devices. In particular embodiments, the CS may set up a GATT server that includes a single service and exposes two characteristics, one for bi-directional communication and the other for notifications for state updates.

The existing protocols, such as GATT, may be overly restrictive. For example, BLE uses fixed-size packets to transfer data (e.g., to “read” or “write” to a characteristic). The size of the packets (termed Maximum Transmission Unit or MTU) may be negotiated during connection establishment, with a default value of, for example, 23 bytes. In addition, different computing devices (or the operating systems thereof) may expose slightly different APIs for implementing the GATT protocol (e.g., certain devices or operating systems may add extra bytes over overhead within an MTU). Rather than accommodating the fixed packet-size limitations and non-uniformity of different protocol implementations, particular embodiments may use a new, improved communication protocol that allows for arbitrary data size communication. In particular embodiments, the protocol may divide large array bytes into MTU-sized chunked with a two-byte overhead per chunk. In particular embodiments, the most significant bit of the two bytes may be the “terminator” bit, which signifies the last byte in a sequence, and the remaining 15 bits may contain an incremental sequence number for the chunk. For 23-byte MTUs, this allows up to 2\hat{ }15 chunks with 21-bytes of payload each, which translates to 2\hat{ }15*21=640 kB of data per message.

Another shortcoming of existing protocols is their security vulnerabilities. Users commonly pass sensitive information between smart devices. For example, a mobile phone connected to a virtual-reality equipment could pass credit card information, passwords, or other private information over the air. Ensuring a secure connection enables users to exchange information with confidence, knowing that third-party attackers will not intercept the information or impersonate the user, for example.

To establish a secure connection (e.g., BLE connection), the computing device needs to be bonded to the user equipment. With BLE, the bonding process requires an exchange of keys/PINs. As described above, however, this may severely impact the new user experience in particular applications. For example, to configure a virtual-reality head-mounted display, the user may have to repeatedly put on and take off the head-mounted display to switch between the CA and CS. To address this shortcoming, particular embodiments, described in further detail below, provide a security protocol for establishing a trusted bond without requiring the user to enter any keys/PINs, thereby providing a frictionless new user experience.

Another aspect of security is to ensure that the user equipment (CS) with which the computing device (CA) communicates is trustworthy before sensitive information is communicated. Even if the communication channel is secure, there remains a security risk if the user equipment is compromised. For example, if the user equipment is tampered with or manufactured by a third party, sensitive information transmitted to the equipment, even if transmitted securely, could be vulnerable once the information arrives. Even if the compromised or third-party user equipment is not maliciously designed, it may not correctly implement the security protocol and thereby introduce a security risk. Thus, in particular embodiments, the user equipment or companion server associated with the companion application (e.g., a virtual-reality head-mounted display associated with a companion application) may securely store a device certificate that can be used by the computing device or any other communication partner to validate the authenticity of the user equipment. For example, the device certificate may contain a variety of information about the user equipment (e.g., serial number, certificate issuer, validity date, company details, public key information, identifier for the issuer, identifier for the company, etc.) that is signed by a certificate authority. At the start of a communication session, the computing device may issue a challenge (e.g., a random nonce) to the user equipment (e.g., a head-mounted display). In response, the user equipment may sign the challenge using the user equipment's device private key and send the signed challenge, also referred to as a signature, along with the device certificate to the computing device. Upon receiving the device certificate, the computing device may validate it against a trusted root certificate (e.g., via a cloud-based service of the certification authority). In addition, the computing device may verify the signed challenge or signature of the user equipment. For example, the computing device may decrypt the signed challenge using the public key in the device certificate and check whether the decrypted result matches the originally issued challenge. If there is a match, the computing device may deem the user equipment as being trust-worthy. As will be described in further detail below, particular embodiments of the security protocol may validate the device certificate during each communication or a subset of communications to ensure that the party with which the CA is communicating is trustworthy.

In addition, particular embodiments described herein provide an efficient protocol for validating a device certificate. As previously described, when the CA first communicates with CS, CS may send its device certificate to CA. Once CA validates the device certificate (e.g., by handing off the device certificate to a cloud-based service associated with a certificate authority that validates the certificate against a trusted certificate chain), the certificate may be stored locally. Communications thereafter may require both parties to have the same device certificate. In particular embodiments, the device certificate may be larger than the maximum payload of a single transmission packet. For example, the device certificate may be a X.509 device certificate that is 2 kilobytes (KB) in size, but the available payload per packet may only be 1 KB (e.g., via BLE). Thus, if the device certificate is transmitted each time, at least two packets would need to be transmitted to send the entire certificate. To reduce latency, particular embodiments of the communication protocol may only require the CA to send a fingerprint of the stored device certificate (e.g., a hash of the device certificate) and transmit the fingerprint using a single packet to the CS for comparison. This provides significant time savings over the duration of the communication process.

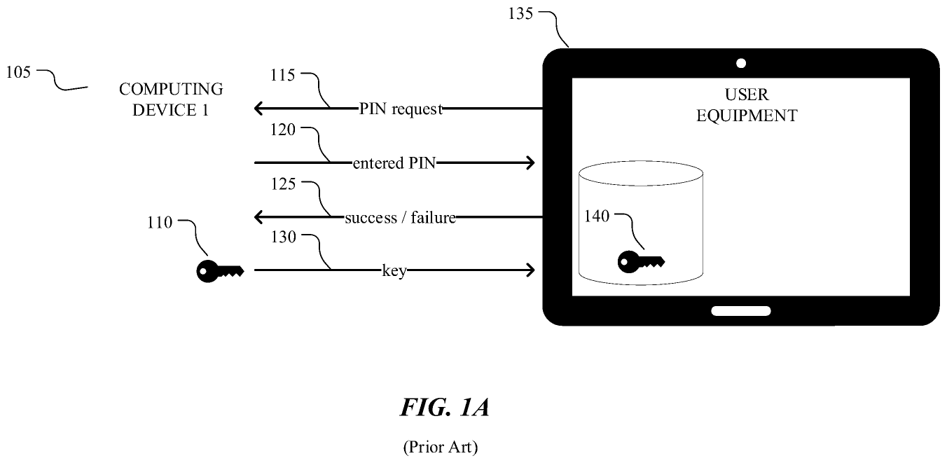

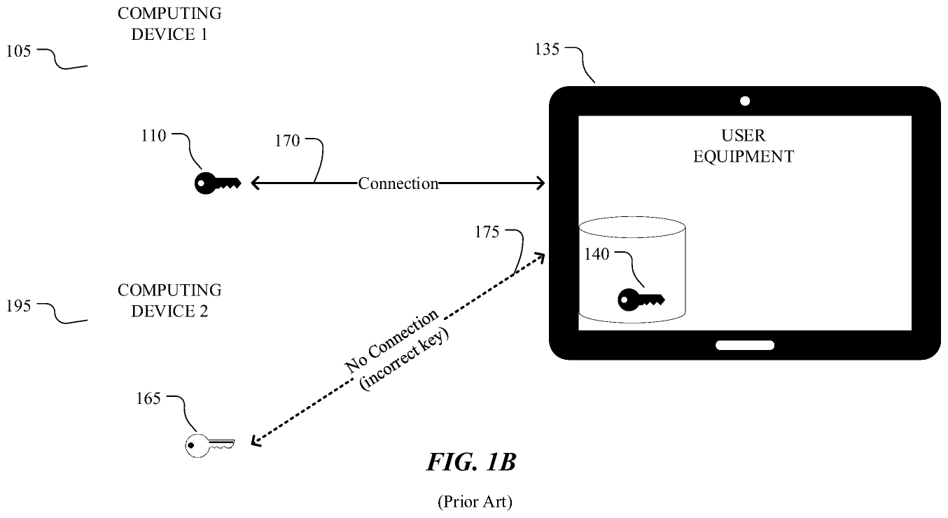

Particular embodiments of the communication protocol further provide users with the flexibility to use different computing devices to communicate with a particular user equipment. This feature addresses one of the shortcomings of traditional communication protocols, such as BLE. FIGS. 1A-1B provide an example of a traditional bonding process, where a device-based bonding key is stored and used for subsequent connections. FIG. 1A illustrates, at a high-level, an initial bonding between a computing device 105 and user equipment 135. The computing device 105 has the bonding key 110 stored locally, or it may be generated based on information associated with the device 105 itself (e.g., the device's MAC address). The process may begin with the user equipment 135 sending a PIN request 115 to the computing device 105. Depending on the configuration, the user may enter the PIN from a display on the computing device 105. The PIN is then transmitted 120 to the user equipment 135. The user equipment 135 then checks the PIN and sends a success/failure message 125 to the computing device 105. If the message 125 indicates that the PIN is correct (i.e., a success), the computing device 105 then retrieves the local bonding key 110 and transmits 130 it to the user equipment 135. The user equipment 135 then stores this bonding key locally 140 for subsequent communications with the computing device 105. At this point, the computing device 105 and the user equipment 135 may be considered to be “bonded” to each other.

FIG. 1B illustrates an example of when a new computing device 195 attempts to communicate with the user equipment 135. The computing device 105 from FIG. 1A is shown to have an active connection 170 with the user equipment 135. The bonding key 110 that is stored locally on computing device 105 is the same as the bonding key 140 stored by the user equipment 135. Because the bonding key 110 of the computing device 105 matches the bonding key 140 stored on the user equipment 135 from the old computing device 105, a connection 170 is established. However, the user of computing device 105 may wish to use a different computing device 195 to communicate with the user equipment 135. There may be a variety of reasons for the user to want to do so, such as losing or replacing the initial computing device 105, wanting to use multiple devices to connect to user equipment 135, etc. However, the new computing device 195 has its own unique bonding key 165 that is tied to the device 195 itself (e.g., its MAC address). Since bonding key 165 does not match the bonding key 140 stored on the user equipment 135, the connection 175 will be rejected. Thus, when the user wishes to use a different computing device to connect to user equipment 135, the user would have to undergo the initial bonding process again to bond the new computing device 195 to the user equipment 135.

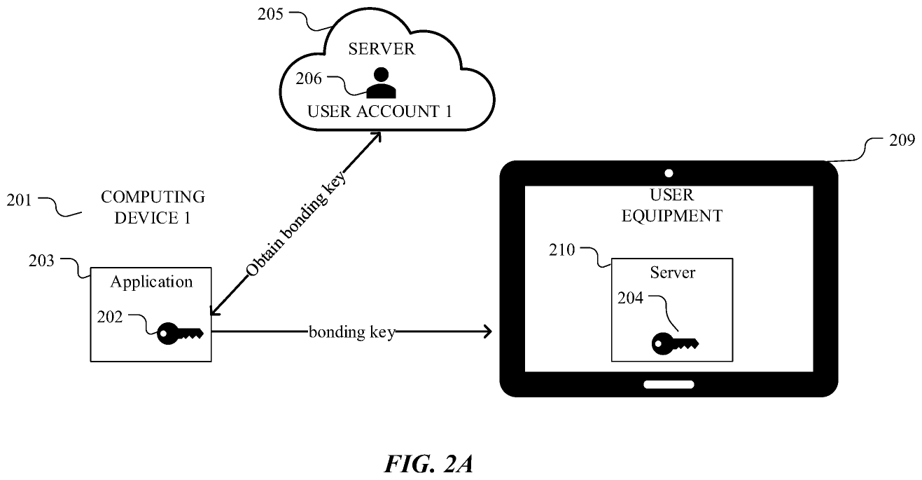

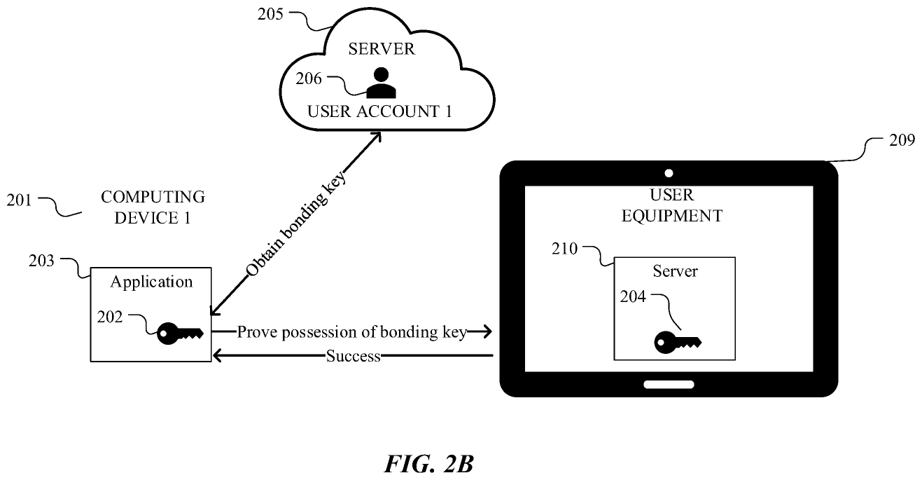

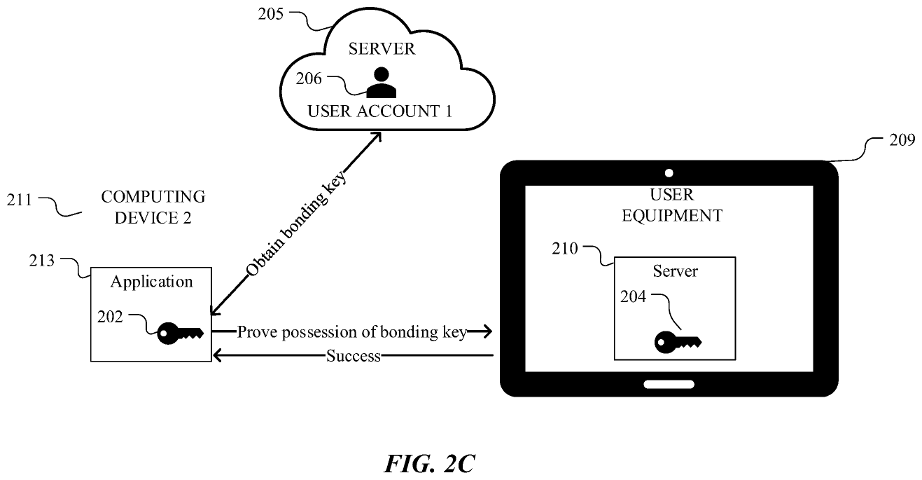

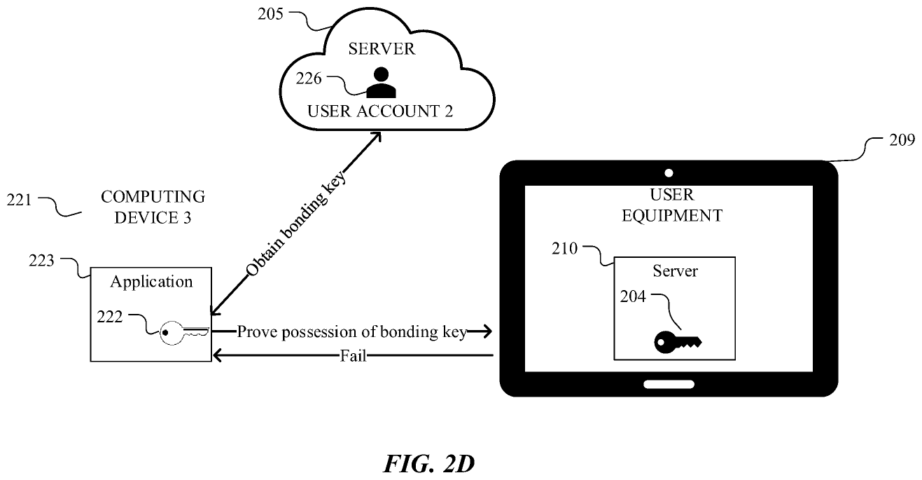

Particular embodiments described herein provide a bonding protocol that does not suffer from the inflexibilities of traditional methods as explained above. FIGS. 2A-2D provide an example of how the bonding protocol may be used in operation under different scenarios. For simplicity, the example shown assumes that communications between the various parties are secure (e.g., after both parties have established a shared secret for encrypting communication and verified authenticity). Details on how secure and trusted communication can be established are described in further detail elsewhere herein.

FIG. 2A provides an example of an initial setup of the bonding process between a computing device 201 and user equipment 209. In particular embodiments, an application 203 (e.g., a companion application) installed and running on the computing device 201 may be configured to interface with the user equipment 209. In operation, the user may log into a remote server 205 through the application 203 to gain access or create a user account 206. The remote server 205 may be a server associated with the user equipment 209 (e.g., the remote server 205 may be hosted by the manufacturer or an affiliate of the user equipment 209), a social networking system, or a trusted third-party that is entrusted with providing the bonding key, or information from which it may be derived, for establishing the bond between the computing device 201 and the user equipment 209.

Once the server 205 authenticates the user's login credentials, the application 203 may obtain a bonding key 202 associated with the user account 206. In particular embodiments, the bonding key 202 may be stored on the server 205 and associated with the user account 206. The bonding key 202 may be generated by the server 205 using information associated with the user's account 206 (e.g., the bonding key 202 may be a hash of one or more of the user's account number, name, etc.) or a random number that is securely stored and associated with the user's account 206. In embodiments where the server 205 is in possession of the bonding key 202, the bonding key 202 may be downloaded onto the computing device 201 and stored locally. In other embodiments, the application 203 may obtain information associated with the user account 206 (e.g., account number, username, birth date, or non-public information such as internal/system user ID or a random number) and locally generate the bonding key 202 for storage. The algorithm or function used for generating the bonding key 202 may be configured to generate the same bonding key 202 given the same inputs. Thus, when the user uses another computing device, so long as it can obtain the same information from the user's account 206, it would be able to generate the same bonding key 202. In some embodiments, the bonding key 202 is stored in the user's session storage associated with the application 203. When the user signs out, the bonding key 202 may be cleared and must be obtained once again from the user account 206 the next time the user wishes to connect to the user equipment 209.

Once the application 203 is in possession of the bonding key 202, it may be securely transmitted (e.g., the communication channel is secured using a shared secret, which will be described in further detail elsewhere herein) to the server 210 (e.g., the aforementioned companion server) running on the user equipment 209. The server 210 may then store a local copy of the bonding key 204 on the user equipment 209. In particular embodiments, the server 210 may be configured to only store a single bonding key 204, which means that only a single user would be able to connect to the user equipment 209. In other embodiments, the server 210 may be configured to store more than one bonding keys, in which case multiple users may be able to connect to the user equipment 209.

FIG. 2B provides an example of a post-setup scenario in accordance with particular embodiments, where the user is connecting to the user equipment 209 using the same computing device 201 that has bonded with the user equipment 209 in FIG. 2A. In this example, the bonding key 202 is derived once again from the user account 206, similar to the process described above. The computing device 201 and the user equipment 209 may first establish a communication session that is secure and trusted, which will be described in further detail below. During the exchange for establishing the secure and trusted communication session, the server 210 may generate an authentication challenge to test whether the application 203 is in possession of the same bonding key 202 as the one 204 stored by the server 210. The authentication challenge is then transmitted to the application 203. The application 203 may sign the authentication challenge using the bonding key 202 (e.g., encrypting the challenge using the bonding key 202) and transmit the signed challenge back to the server 210. The server 210 may be configured to verify the signed challenge in order to verify that the transmitter, in this case the application 203 on the computing device 201, has proven that it is in possession of the bonding key 202. The server 210 may verify the signed challenge using its locally-stored bonding key 204. For example, the server 210 may decrypt the signed challenge using its stored bonding key 204. If the decrypted signed challenge and the original challenge sent by the server 210 match, then the server 210 may send back a success message to indicate that the application 203 has successfully proven that it has possession of the same bonding key 202. Thereafter, the computing device 201 and the user equipment 209 may engage in a trusted communication.

FIG. 2C provides an example of another post-setup scenario in accordance with particular embodiments, where the same user is connecting to the user equipment 209 using a different computing device 211 (hereinafter referred to as the “new computing device”). In particular embodiments, the new computing device 211 may also have an instance of the companion application 213 installed and running. Through the application 213, the user may enter credentials for logging into user account 206 on the remote server 205. Since the user is logged into the same user account 206 as before, the user may obtain the same bonding key 202 as the one obtained before. Again, the new computing device 211 and the user equipment 209 may first establish a communication session that is secure and trusted, which will be described in further detail below. During the exchange for establishing the secure and trusted communication session, the server 210 may generate an authentication challenge to test whether the application 213 on the new computing device 211 is in possession of the same bonding key 202 as the one 204 stored by the server 210. The authentication challenge is then transmitted to the application 213. The application 213 may sign the authentication challenge using the bonding key 202 (e.g., encrypting the challenge using the bonding key 202) and transmit the signed challenge back to the server 210. The server 210 may be configured to verify the signed challenge in order to verify that the transmitter, in this case the application 213 on the computing device 211, has proven that it is in possession of the bonding key 202. The server 210 may verify the signed challenge using its locally-stored bonding key 204. For example, the server 210 may decrypt the signed challenge using its stored bonding key 204. If the decrypted signed challenge and the original challenge sent by the server 210 match, then the server 210 may send back a success message to indicate that the application 213 has successfully proven that it has possession of the same bonding key 202. Thereafter, the new computing device 211 and the user equipment 209 may engage in a trusted communication.

Because the bonding key 202 on the new computing device 211 is derived from a remote user account 206, the user does not need to establish a new bonding for the new computing device 211. This addresses the above-mentioned need for an improvement in user convenience. Unlike the scenario shown in FIG. 1B, where the new computing device 195 is unable to connect to the user equipment 135 without a new bonding being established, the new computing device 211 in FIG. 2C is able to seamlessly connect to the user equipment 209 by deriving the same bonding key 202 from the user account 206. This feature makes it possible for the user to switch computing devices as he pleases, including using someone else's computing device, without having to undergo the initial bonding process again. Further, the user's ability to switch devices is not limited by the number of bondings allowed by the user equipment 209. For example, even if the user equipment 209 only supports a single bonding, having the bonding key 202 conceptually tied to the user's account 206 makes it possible for the user to use any number of devices so long as he provides the credentials for the user account 206. The same cannot be said of traditional processes, such as the one described with reference to FIGS. 1A-1B, since the bonding key 110 there is device-specific.

FIG. 2D provides an example of another post-setup scenario in accordance with particular embodiments, where a different user is trying to connect to the user equipment 209. In particular embodiments, the new user's computing device 221 may also have an instance of the companion application 223 installed and running. Through the application 223, the user may enter credentials for logging into his user account 226 on the remote server 205, different from the user account 206 shown in FIGS. 2A-C. Since the user is logged into a different user account 226, the user would obtain a bonding key 222 that is different from the bonding key 202 shown in FIGS. 2A-C. During the exchange for establishing the secure and trusted communication session, the server 210 may generate an authentication challenge to test whether the application 223 on the new computing device 221 is in possession of the same bonding key 222 as the one 204 stored by the server 210. The authentication challenge is then transmitted to the application 223. The application 223 may sign the authentication challenge using the bonding key 222 (e.g., encrypting the challenge using the bonding key 222) and transmit the signed challenge back to the server 210. The server 210 may be configured to verify the signed challenge in order to verify that the transmitter, in this case the application 223 on the computing device 221, has proven that its bonding key is the same as the one 204 stored on the server. The server 210 may verify the signed challenge using its locally-stored bonding key 204. For example, the server 210 may decrypt the signed challenge using its stored bonding key 204. However, since the stored bonding key 204 stored by the server 210 is different from the bonding key 222 used to sign the authentication challenge, the verification would fail in this case since the decrypted signed challenge would not match the original challenge (in other words, the computing device 221 failed to prove that it is in possession of the same bonding key as the one stored by the user equipment 209). Consequently, the server 210 would send back a message indicating failure and no trusted connection would be established. As illustrated in this example, requiring a match in the bonding keys prevents computing devices without access to the remote user account 206 from accessing or communicating with the user equipment 209. This allows for a trusted connection between the computing device and the user equipment 209, where both parties are protected from malicious third parties attempting to intercept sensitive information or impersonate one party to illicitly receive sensitive information.

In particular embodiments, user equipment may be bonded to (or claimed by) a single user account. Each user account, in particular embodiments, may be bonded to (or claim) more than one user equipment. For example, new user equipment (e.g., one that has not yet been configured) would be unclaimed, and any user may claim it using the associated companion application (CA). Once the first set of communication is established, the CA may send a secret (e.g., bonding key) derived from the user's account to the user equipment. The companion server running on the user equipment may then store the secret locally. Thereafter, the user may connect to the user equipment so long as he can log into his user account via any CA on any device. If any other user tries to connect to the same user equipment via the companion server without logging into the original user's account, an error would be returned since the new user's bonding key would not match the bonding key that is stored on the user equipment. To be able to use the claimed user equipment with the new account, the user equipment would need to be factory-reset, in accordance with particular embodiments.

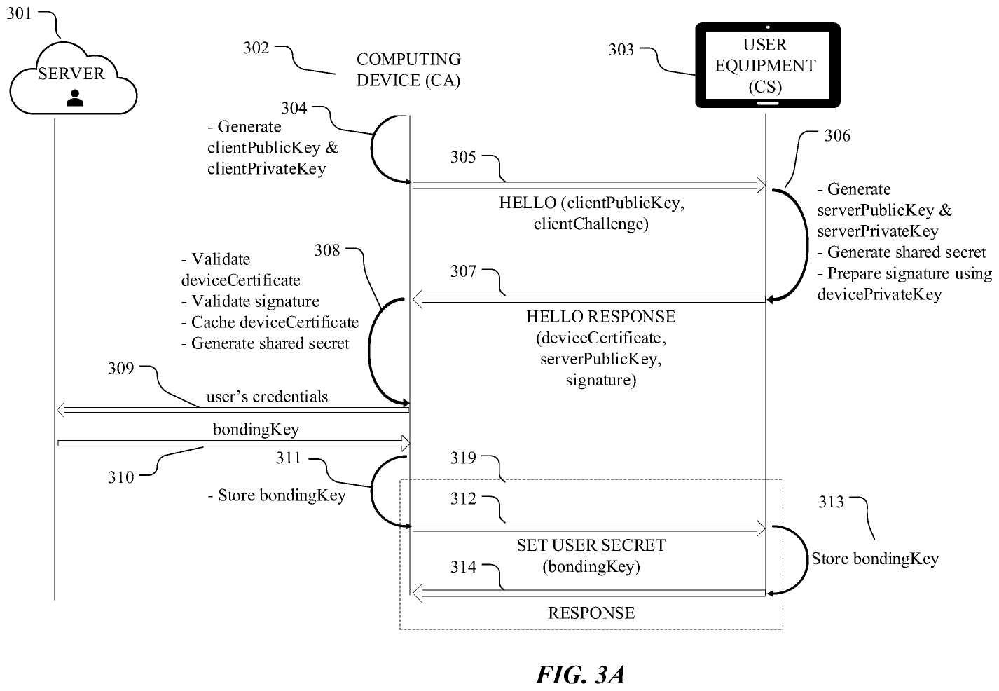

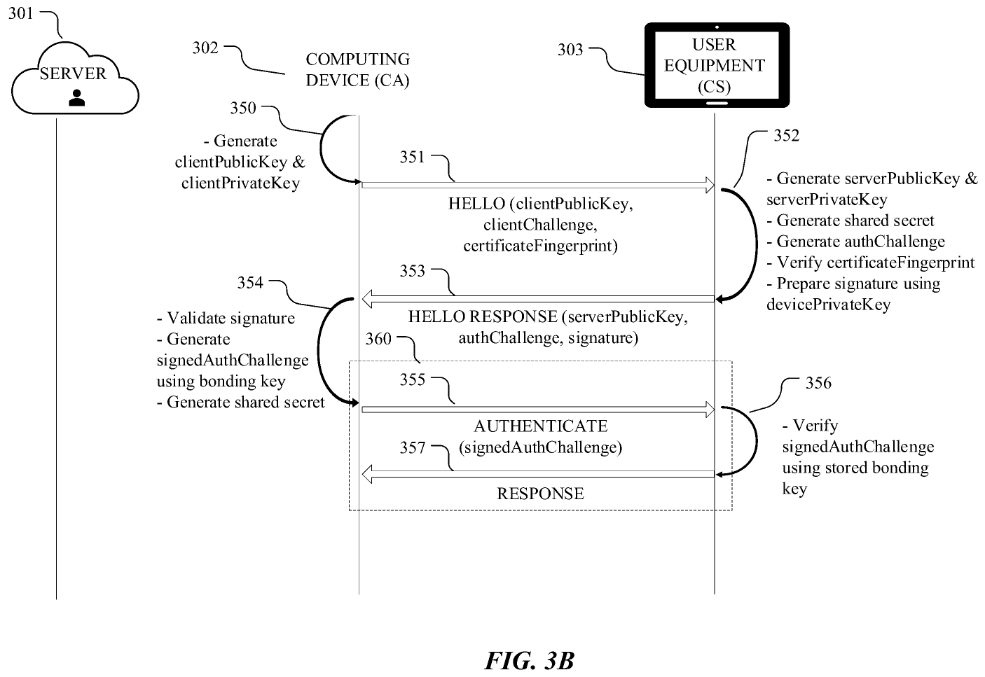

FIG. 3A provides a communication timing diagram of an initial setup scenario in particular embodiments of the bonding procedure described herein. The diagram shows communication between a remote server 301 with which the user has a user account, a computing device 302 configured to operate in accordance with a companion application (CA), and user equipment 303 (e.g., an AR/VR head-mounted display) configured to operate in accordance with a companion server (CS). One goal of the bonding procedure is to establish a secure and trusted communication channel between the CA and CS. Although certain communication protocols, such as Bluetooth® short-range wireless technology, have their own security features, different operating systems used by the computing device may implement slightly different versions of the protocol (e.g., with different security features, fixed message size, etc.). Thus, one advantage of implementing a separate security feature on top of the underlying communication protocol (e.g., BLE) is to improve the robustness of the embodiments described herein.

In particular embodiments, security and trust may be established by having the two parties generate a shared secret that can be used for encrypting/decrypting messages and verify the authenticity of the communication partner. In particular embodiments, to establish a secure communication channel with the user equipment 303, the computing device 302 may first generate a pair of public (referred to as clientPublicKey) and private (referred to as clientPrivateKey) keys 304 using any suitable technique for generating public and private keys. The computing device 302 may then send a HELLO message 305 that includes the clientPublicKey and a randomly-generated challenge (referred to as clientChallenge) to the user equipment 303. The clientPublicKey is intended to be used by the user equipment 303 to generate a shared secret for securing the communication channel, and the clientChallenge is intended for testing whether the user equipment 303 is trustworthy.

In response to the HELLO message 305, the user equipment 303 may perform a series of operations 306 to prepare a response. In particular embodiments, the user equipment 303, through the CS, may generate a pair of public (referred to as serverPublicKey) and private (referred to as serverPrivateKey) keys. The serverPublicKey and serverPrivateKey generated by the user equipment 303 and the clientPublicKey and clientPrivateKey generated by the computing device 302 may be used to establish a shared secret for cryptographically securing communications between the parties. In particular embodiments where Elliptic-curve Diffie-Hellman or ECDH protocol is used, each party may use its own private key and the other party's public key to deduce a common shared secret for securing the communication. In particular embodiments, the public/private key pairs and the corresponding shared secret may be newly generated for every communication session.

In particular embodiments, the shared secret may be established as follows without ever sending it over the wire or air. The user equipment 303 (CS) may generate the shared secret using the locally-generated serverPrivateKey and the clientPublicKey received from the computing device 302 (CA). In particular embodiments, the shared secret may be generated using, for example, Elliptic-curve Diffie-Hellman or ECDH protocol or any other suitable protocols for generating shared secrets. In order to help the computing device 302 generate the shared secret on its own, the user equipment 303 may prepare a message payload that includes the serverPublicKey. As will be described in subsequent stages of the protocol, serverPublicKey, when received by the computing device 302, may be used in conjunction with clientPrivateKey to generate the shared secret.

In addition to the serverPublicKey, the user equipment 303 may include additional data in its HELLO RESPONSE 307 prove to the computing device 302 that the user equipment 303 is trustworthy. In particular embodiments, the HELLO RESPONSE 307 may further include a device certificate (referred to as deviceCertificate). As described elsewhere herein, the deviceCertificate may be signed by a certificate authority and stored securely on the user equipment 303. The deviceCertificate, which may be a X.509 certificate, may be installed during manufacturing and unique to every user equipment 303. For example, the deviceCertificate may be associated with a serial number of the user equipment 303, which may be used by the computing device 302 to verify that the user equipment 303 corresponds to the serial number embedded in the deviceCertificate. The deviceCertificate may also include a public key (referred to as devicePublicKey). The deviceCertificate may also be included in the HELLO RESPONSE 307. Verification of the deviceCertificate will be described in further detail below.

In particular embodiments, the user equipment 303 may prove that it is trustworthy by signing the clientChallenge from the computing device 302. In particular embodiments, the user equipment may concatenate the clientChallenge and the serverPublicKey, generate a hash of the concatenated result, and generate a signature by encrypting the hash using a devicePrivateKey that is persistently stored. In particular embodiments, the user equipment 303 may be provisioned with the devicePrivateKey by its manufacturer. The devicePrivateKey and the aforementioned devicePublicKey, which may be included in the deviceCertificate, form a pair of private-public keys. The devicePrivateKey may be securely stored so that no other device has access to it (in other words, the devicePrivateKey is tamper-resistant and inaccessible by unauthorized parties). As will be shown in subsequent stages of the protocol, generating the signature using the devicePrivateKey allows the computing device 302 to verify the authenticity of the user equipment 303 when the signature is verified using the devicePublicKey. In other words, usage of the devicePrivateKey to generate the signature allows the CA to verify that the CS is in possession of the devicePrivateKey, which in turn proves that the user equipment 303 is indeed manufactured by the user equipment's 303 manufacturer. In addition, since communication from the user equipment 303 is signed by devicePrivateKey, certain rights tied to that particular user equipment 303 may be granted or revoked using the devicePrivateKey. For example, if a particular user equipment 303 (e.g., a virtual-reality gaming device) has installed software that enables it to cheat, the gaming server may impose certain restrictions that are tied to communications signed using the particular devicePrivateKey of that user equipment 303.

In particular embodiments, the user equipment 303 may drop all previous connections and use the shared secret between the computing device 302 and the user equipment 303 for further communications within the session. The user equipment 303 may then send a HELLO RESPONSE 307 that includes the deviceCertificate, serverPublicKey, and the signature.

Upon receiving the HELLO RESPONSE 307, the computing device 302 may perform a number of operations 308 to complete the establishment of the secure and trusted connection. In particular embodiments, the computing device 302 may verify whether the sender of the HELLO RESPONSE 307, which is the user equipment 303 in this case, is trustworthy. To do so, the computing device 302 may validate the deviceCertificate by sending it to the appropriate web service(s) (e.g., hosted by the server 301 or another server), which may then verify with the appropriate certificate authority that the deviceCertificate is indeed signed by the proper authorities all the way to the manufacturer of the user equipment 303. In addition, the computing device 302 may validate the signature in the HELLO RESPONSE 307. In particular embodiments, the computing device 302 may decrypt the signature using the devicePublicKey included in the deviceCertificate. The decrypted result may be a hash, which will be referred to as Hd for ease of reference. As previously described, the signature was generated by encrypting, using devicePrivateKey, a hash of the concatenated result of the serverPublicKey and the clientChallenge. Thus, the computing device 302 may also concatenate the serverPublicKey received from the HELLO RESPONSE 307 and the clientChallenge that was sent, and then generate a hash H of the concatenated result. If the generated hash H and the decrypted Hd match, then the computing device 302 may conclude that the user equipment 303 has possession of the devicePrivateKey. Thus, if validation of both the deviceCertificate and the signature succeeds, the computing device 302 may deem the user equipment 303 as trustworthy and store (e.g., cache) the deviceCertificate locally; otherwise, it is discarded and the connection fails. In this manner, the computing device 302 ensures that it is communicating with a trusted equipment 303.

With respect to establishing a secure communication channel, the computing device 302 may generate the aforementioned shared secret locally. Using a key generation protocol such as ECDH, the computing device 302 may generate the shared secret using its own clientPrivateKey and the serverPublicKey received from the HELLO RESPONSE 307. Thereafter, both the computing device 302 and the user equipment 303 would be in possession of the shared secret, which may be used to securely encrypt messages between the parties.

In particular embodiments, the computing device 302 may recognize from the HELLO RESPONSE 307 that the user equipment 303 is not yet bonded to a user account. This may be inferred from the payload of the HELLO RESPONSE 307 (e.g., it may lack the deviceCertificate) or indicated by a flag in the HELLO RESPONSE 307 (e.g., a binary bit, with 1 indicating that the user equipment has been bonded and 0 indicating that it has not been bonded). In response, the computing device 302 may obtain a secret bonding key and securely share it with the user equipment 303. In particular embodiments, the computing device 302 may connect 309 to the user's account on the server 301 using, for example, the user's credentials, and obtain 310 the bonding key associated with the user account. The bonding key may then be stored 311 locally on the computing device 302. In particular embodiments, the local storage 311 may be tied to the current user session, which means that if the session were to terminate, the locally stored bonding key would be cleared from storage. In particular embodiments, the secret bonding key may be unique and persisted (stored in a non-transitory medium) for each user account on the server 301. For example, the bonding key may be a random number (e.g., 16 or 32 bytes of random data) generated by the server 301 and tied to the user account. The bonding key has several advantages. For example, it is advantageous over the user's account ID since the ID is predictable. As another example, the bonding key is advantageous over access tokens because access tokens could expire, which means if the CA and CS are separated for some time and that token expires, no one could communicate with the CS. The unique and persisted bonding key serves to be the proof that its possessor (e.g., the computing device 302) has access to the user's account.

Having obtained the bonding key, the computing device 302 may share the bonding key with the user equipment 303 in order to bond with it. The sharing of the bonding key may be performed in a secure communication session 319 using the aforementioned shared secret. For example, the computing device 302 may encrypt the bonding key using the shared secret and send a SET USER SECRET message 312 containing the encrypted bonding key. Upon receiving the message 312, the user equipment 303 may decrypt the message using its copy of the shared secret and obtain the bonding key. The bonding key may then be stored 313 in a secure location on the user equipment 303. If this process is successful, the user equipment 303 would send a RESPONSE 314 indicating that the operation was successful. Thereafter, any communication with the user equipment 303 would require the communicator (e.g., computing device 302) to prove that it has the bonding key (which in turn is proof that the communicator has access to the user's account).

FIG. 3B provides an example timing diagram of a post-setup scenario where the computing device 302 and the user equipment 303 have already been bonded. When the computing device 302 wishes to connect to the user equipment 303, it would create a secure and trusted connection. Computing device 302 may again generate a public and private key pair (again referred to as clientPublicKey and clientPrivateKey). In particular embodiments, the computing device 302 may generate another challenge (referred to as clientChallenge) that will be used to test whether the user equipment 303 is authentic. The computing device 302 may further check whether it has a cached deviceCertificate, obtained during the process described above with reference to FIG. 3A. If the deviceCertificate is cached, it means that the deviceCertificate has already been validated, as described above. In particular embodiments, the computing device 302 may check whether the cached deviceCertificate belongs to its current communication partner, the user equipment 303. One way to do so may be to send the deviceCertificate to the user equipment 303 for comparison. However, the deviceCertificate may be relatively large (e.g., 2 kilobytes) compared to the maximum payload of each transmission packets (e.g., 1 kilobyte). As such, the transmission of the deviceCertificate would require multiple packets, which introduces delay. To illustrate, if the transmission cycle of the communication protocol is one packet per 0.1 seconds, then sending the deviceCertificate would take at least 0.2 seconds to transmit. Particular embodiments avoid sending the deviceCertificate by sending a smaller fingerprint of the deviceCertificate instead. The computing device 302 may generate a corresponding fingerprint of the deviceCertificate (referred to as certificateFingerprint) or retrieve a previously-generated certificateFingerprint. In particular embodiments, the certificateFingerprint may be a hash of the deviceCertificate. The smaller size of the certificateFingerprint allows fewer transmission packets (and consequently, lesser time) to be used for sending a HELLO message 351 containing the certificateFingerprint, compared to a HELLO message containing the full deviceCertificate. The clientPublicKey, the clientChallenge, and the certificateFingerprint may be included in the HELLO message 351 and transmitted to the user equipment 303.

In response to the HELLO message 351, the user equipment 303 may check to see whether it includes a certificateFingerprint. If so, the user equipment 303 may check whether the certificateFingerprint matches a hash (or a second fingerprint) of the user equipment's 303 own copy of the deviceCertificate. If no certificateFingerprint is included or there is a mismatch (which would be the case in the initial setup scenario shown in FIG. 3A), then the user equipment 303 may include the deviceCertificate in its HELLO RESPONSE (e.g., RESPONSE 307 in FIG. 3A). On the other hand, if the two fingerprints match, then the deviceCertificate would not need to be included in the HELLO RESPONSE 353, thereby avoiding the need to transmit the deviceCertificate and obviating the need for the computing device 302 to again validate the deviceCertificate.

Since the communication at this point may not yet be secure, the parties need to establish a secure connection. Similar to the process described with reference to FIG. 3A, the user equipment 303 may generate a pair of public/private keys (referred to as serverPublicKey and serverPrivateKey) for the current communication session. In particular embodiments, the user equipment 303 may generate a shared secret (e.g., using ECDH) based on its serverPrivateKey and the clientPublicKey that is included in the HELLO message 351. The serverPublicKey may later be shared with the computing device 302 so that it may also generate the shared secret locally without the shared secret ever being exposed during transmission. As will be described in further detail below, once both parties have the shared secret, subsequent communication could be encrypted based on a shared secret.

In particular embodiments, the user equipment 303, which is already bonded to a user account in this example, may require the computing device 302 prove that it has access to the same user account. In particular embodiments, the user equipment 303 may generate an authentication challenge (referred to as authChallenge), which could be randomly generated data, with the intention of using it to test whether the computing device 302 can prove that it has access to the user account.

In particular embodiments, the user equipment 303 may prove that it is trustworthy or authentic by generating a signature using its devicePrivateKey, as previously described. The signature may be generated by using the devicePrivateKey to encrypt data derived from the clientChallenge. As explained thus far, the payload of the HELLO RESPONSE 353 may include the serverPublicKey (for establishing a secure communication channel with the computing device 302) and the authChallenge (for proving that the computing device has access to the user account bonded to the user equipment 303). Thus, in particular embodiments, the user equipment 303 may concatenate the serverPublicKey, authChallenge, and the clientChallenge and generate a hash of the concatenated result. The resulting hash may then be signed (encrypted) using the devicePrivateKey, as described above, resulting in a signature. The HELLO RESPONSE 353 may include the payload (e.g., the serverPublicKey and authChallenge) and the signature. In particular embodiments, the user equipment 303 may drop all previous connection at this point.

When the computing device 302 receives the HELLO RESPONSE 353, it may complete the setup 354 for the secure and trusted connection. Similar to the process described with reference to FIG. 3A, the computing device 302 may validate the signature. For example, the computing device 302 may use the devicePublicKey in the cached deviceCertificate to decrypt the signature to retrieve the hash, which will be referred to as Hd. The computing device 302 may then concatenate the serverPublicKey and authChallenge, which are included in the HELLO RESPONSE 353, with the original copy of the clientChallenge that was sent to the user equipment 303 in the HELLO message 351. The concatenated result may be hashed to generate hash H. The decrypted hash Hd may then be compared with hash H. If the two match, then the signature is validated, which means that the user equipment 303 is trustworthy; otherwise, further communication may be rejected.

In addition to validating the authenticity of the user equipment 303, the computing device 302 also may complete the process for securing the communication channel by generating the shared secret. The shared secret may be generated (e.g., using ECDH) based on the computing device's 302 clientPrivateKey and the serverPublicKey in the HELLO RESPONSE 353. Thereafter, communications between the two may be encrypted and decrypted using the shared secret.

The computing device 302, in particular embodiments, may also generate a proof demonstrating that it has access to the same user account to which the user equipment 303 is bonded. In particular embodiments, the computing device 302 may sign the authChallenge obtained from the HELLO RESPONSE 353 using the locally stored bonding key. If the bonding key is unavailable, the user may log into a user account on server 301 and obtain the associated bonding key (not shown in FIG. 3B). The signed authChallenge, referred to as signedAuthChallenge, may then be transmitted in a message 355 to the user equipment 303. The use of the signedAuthChallenge as the proof of possession of the bonding key is more secure than sending the bonding key itself. Since a secure connection 360 has now been established (e.g., based on the shared secret), the message 355 may be securely sent. Upon receiving the message 355, the user equipment 303 may verify that the signedAuthChallenge provided by computing device 302 proves that the computing device 302 has access to the same user account to which the user equipment 303 is bonded. In particular embodiments, the user equipment 303 may decrypt the signedAuthChallenge using the locally stored bonding key. If the decrypted result matches the original authChallenge generated by the user equipment 303 (e.g., in step 352), then the user equipment 303 may conclude that the computing device 302 has proven that it has the same bonding key associated with the same user account and send a RESPONSE 357 indicating success. On the other hand, a mismatch between the decrypted authChallenge and the original authChallenge indicates that the computing device 302 does not have the same bonding key, which in turn means that the computing device 302 has failed to prove that it has access to the user account bonded to the user equipment 303. As such, the user equipment 303 may send a response 357 indicating failure and reject the connection.

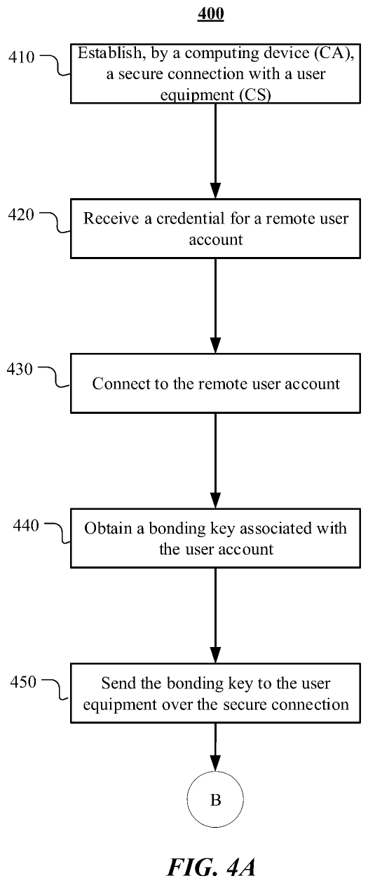

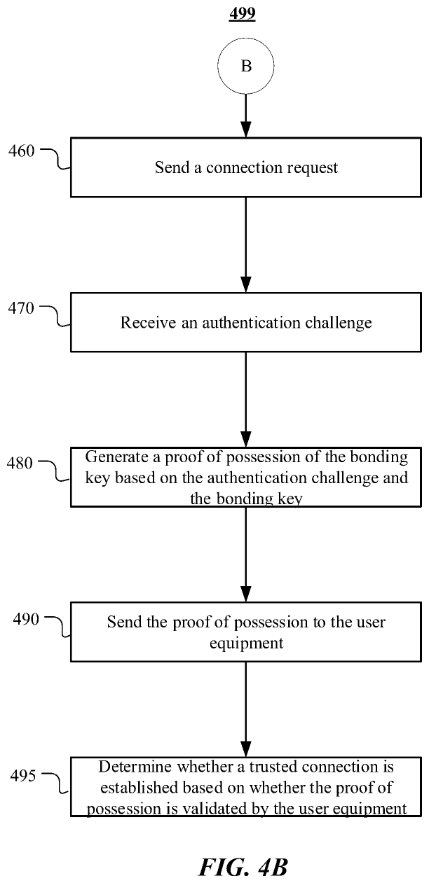

FIG. 4A illustrates an example method 400 for bonding a computing device and user equipment, in accordance with particular embodiments. The method may begin at step 410, where the computing device (e.g., configured to operate in accordance with a companion application) may establish a secure connection with user equipment (e.g., one configured to operate in accordance with a companion server). At step 420, the computing device may receive a credential for a remote user account. In other embodiments, the credential may be prestored by the computing device, in which case step 420 may occur prior to step 410. At step 430, the computing device may connect to the remote user account based on the credential. At step 440, the computing device may obtain a bonding key associated with the remote user account. At step 450, the computing device may send the bonding key to the user equipment through the secure connection for storage by the user equipment. Subsequent to the sending of the bonding key, proof of possession of the bonding key may be required for establishing a trusted connection with the user equipment. Particular embodiments may repeat one or more steps of the method of FIG. 4A, where appropriate. Although this disclosure describes and illustrates particular steps of the method of FIG. 4A as occurring in a particular order, this disclosure contemplates any suitable steps of the method of FIG. 4A occurring in any suitable order. Moreover, although this disclosure describes and illustrates an example method for bonding a computing device and user equipment, including the particular steps of the method of FIG. 4A, this disclosure contemplates any suitable method for doing so including any suitable steps, which may include all or some of the steps of the method of FIG. 4A, where appropriate. Furthermore, although this disclosure describes and illustrates particular components, devices, or systems carrying out particular steps of the method of FIG. 4A, this disclosure contemplates any suitable combination of any suitable components, devices, or systems carrying out any suitable steps of the method of FIG. 4A.

FIG. 4B illustrates an example method 499 for establishing a trusted connection with user equipment that has been bonded (e.g., after the method of FIG. 4A). The method may begin at step 460, where the computing device may send a connection request to the user equipment after the bonding key was sent and stored by the user equipment. At step 470, the computing device may receive an authentication challenge generated by the user equipment in response to the connection request. At step 480, the computing device may generate a proof of possession of the bonding key based on the received authentication challenge and the bonding key. For example, the computing device may sign the authentication challenge using the bonding key. At step 490, the computing device may send the proof of possession of the bonding key to the user equipment. The proof of possession of the bonding key may be configured to be validated by the user equipment using the bonding key stored by the user equipment. For example, the user equipment may decrypt the signed authentication challenge and compare the decrypted result with the original authentication challenge that was sent to the computing device. If a match is found, then the proof of possession is validated. At step 495, the computing device may determine whether a trusted connection is established with the user equipment based on whether the proof of possession of the bonding key is validated by the user equipment. Particular embodiments may repeat one or more steps of the method of FIG. 4B, where appropriate. Although this disclosure describes and illustrates particular steps of the method of FIG. 4B as occurring in a particular order, this disclosure contemplates any suitable steps of the method of FIG. 4B occurring in any suitable order. Moreover, although this disclosure describes and illustrates an example method for establishing a trusted connection with user equipment that has been bonded, including the particular steps of the method of FIG. 4B, this disclosure contemplates any suitable method for doing so including any suitable steps, which may include all or some of the steps of the method of FIG. 4B, where appropriate. Furthermore, although this disclosure describes and illustrates particular components, devices, or systems carrying out particular steps of the method of FIG. 4B, this disclosure contemplates any suitable combination of any suitable components, devices, or systems carrying out any suitable steps of the method of FIG. 4B.

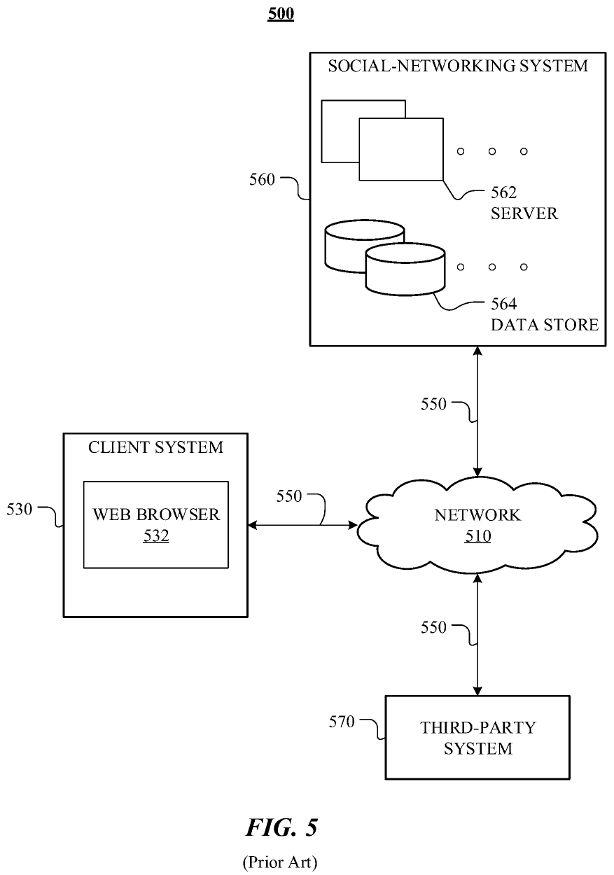

FIG. 5 illustrates an example network environment 500 associated with a social-networking system. Network environment 500 includes a client system 530, a social-networking system 560, and a third-party system 570 connected to each other by a network 510. Although FIG. 5 illustrates a particular arrangement of client system 530, social-networking system 560, third-party system 570, and network 510, this disclosure contemplates any suitable arrangement of client system 530, social-networking system 560, third-party system 570, and network 510. As an example and not by way of limitation, two or more of client system 530, social-networking system 560, and third-party system 570 may be connected to each other directly, bypassing network 510. As another example, two or more of client system 530, social-networking system 560, and third-party system 570 may be physically or logically co-located with each other in whole or in part. Moreover, although FIG. 5 illustrates a particular number of client systems 530, social-networking systems 560, third-party systems 570, and networks 510, this disclosure contemplates any suitable number of client systems 530, social-networking systems 560, third-party systems 570, and networks 510. As an example and not by way of limitation, network environment 500 may include multiple client system 530, social-networking systems 560, third-party systems 570, and networks 510.

This disclosure contemplates any suitable network 510. As an example and not by way of limitation, one or more portions of network 510 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 510 may include one or more networks 510.

Links 550 may connect client system 530, social-networking system 560, and third-party system 570 to communication network 510 or to each other. This disclosure contemplates any suitable links 550. In particular embodiments, one or more links 550 include one or more wireline (such as for example Digital Subscriber Line (DSL) or Data Over Cable Service Interface Specification (DOCSIS)), wireless (such as for example Wi-Fi™ or Worldwide Interoperability for Microwave Access (WiMAX)), or optical (such as for example Synchronous Optical Network (SONET) or Synchronous Digital Hierarchy (SDH)) links. In particular embodiments, one or more links 550 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 550, or a combination of two or more such links 550. Links 550 need not necessarily be the same throughout network environment 500. One or more first links 550 may differ in one or more respects from one or more second links 550.

In particular embodiments, client system 530 may be an electronic device including hardware, software, or embedded logic components or a combination of two or more such components and capable of carrying out the appropriate functionalities implemented or supported by client system 530. As an example and not by way of limitation, a client system 530 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 530. A client system 530 may enable a network user at client system 530 to access network 510. A client system 530 may enable its user to communicate with other users at other client systems 530.

In particular embodiments, client system 530 may include a web browser 532 and may have one or more add-ons, plug-ins, or other extensions. A user at client system 530 may enter a Uniform Resource Locator (URL) or other address directing the web browser 532 to a particular server (such as server 562, or a server associated with a third-party system 570), and the web browser 532 may generate a Hyper Text Transfer Protocol (HTTP) request and communicate the HTTP request to server. The server may accept the HTTP request and communicate to client system 530 one or more Hyper Text Markup Language (HTML) files responsive to the HTTP request. Client system 530 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts, combinations of markup language and scripts, and the like. Herein, reference to a webpage encompasses one or more corresponding webpage files (which a browser may use to render the webpage) and vice versa, where appropriate.

In particular embodiments, social-networking system 560 may be a network-addressable computing system that can host an online social network. Social-networking system 560 may generate, store, receive, and send social-networking data, such as, for example, user-profile data, concept-profile data, social-graph information, or other suitable data related to the online social network. Social-networking system 560 may be accessed by the other components of network environment 500 either directly or via network 510. As an example and not by way of limitation, client system 530 may access social-networking system 560 using a web browser 532, or a native application associated with social-networking system 560 (e.g., a mobile social-networking application, a messaging application, another suitable application, or any combination thereof) either directly or via network 510. In particular embodiments, social-networking system 560 may include one or more servers 562. Each server 562 may be a unitary server or a distributed server spanning multiple computers or multiple datacenters. Servers 562 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 562 may include hardware, software, or embedded logic components or a combination of two or more such components for carrying out the appropriate functionalities implemented or supported by server 562. In particular embodiments, social-networking system 560 may include one or more data stores 564. Data stores 564 may be used to store various types of information. In particular embodiments, the information stored in data stores 564 may be organized according to specific data structures. In particular embodiments, each data store 564 may be a relational, columnar, correlation, or other suitable database. Although this disclosure describes or illustrates particular types of databases, this disclosure contemplates any suitable types of databases. Particular embodiments may provide interfaces that enable a client system 530, a social-networking system 560, or a third-party system 570 to manage, retrieve, modify, add, or delete, the information stored in data store 564.

In particular embodiments, social-networking system 560 may store one or more social graphs in one or more data stores 564. In particular embodiments, a social graph may include multiple nodes—which may include multiple user nodes (each corresponding to a particular user) or multiple concept nodes (each corresponding to a particular concept)—and multiple edges connecting the nodes. Social-networking system 560 may provide users of the online social network the ability to communicate and interact with other users. In particular embodiments, users may join the online social network via social-networking system 560 and then add connections (e.g., relationships) to a number of other users of social-networking system 560 to whom they want to be connected. Herein, the term “friend” may refer to any other user of social-networking system 560 with whom a user has formed a connection, association, or relationship via social-networking system 560.

In particular embodiments, social-networking system 560 may provide users with the ability to take actions on various types of items or objects, supported by social-networking system 560. As an example and not by way of limitation, the items and objects may include groups or social networks to which users of social-networking system 560 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 560 or by an external system of third-party system 570, which is separate from social-networking system 560 and coupled to social-networking system 560 via a network 510.

In particular embodiments, social-networking system 560 may be capable of linking a variety of entities. As an example and not by way of limitation, social-networking system 560 may enable users to interact with each other as well as receive content from third-party systems 570 or other entities, or to allow users to interact with these entities through an application programming interfaces (API) or other communication channels.

In particular embodiments, a third-party system 570 may include one or more types of servers, one or more data stores, one or more interfaces, including but not limited to APIs, one or more web services, one or more content sources, one or more networks, or any other suitable components, e.g., that servers may communicate with. A third-party system 570 may be operated by a different entity from an entity operating social-networking system 560. In particular embodiments, however, social-networking system 560 and third-party systems 570 may operate in conjunction with each other to provide social-networking services to users of social-networking system 560 or third-party systems 570. In this sense, social-networking system 560 may provide a platform, or backbone, which other systems, such as third-party systems 570, may use to provide social-networking services and functionality to users across the Internet.

In particular embodiments, a third-party system 570 may include a third-party content object provider. A third-party content object provider may include one or more sources of content objects, which may be communicated to a client system 530. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 560 also includes user-generated content objects, which may enhance a user's interactions with social-networking system 560. User-generated content may include anything a user can add, upload, send, or “post” to social-networking system 560. As an example and not by way of limitation, a user communicates posts to social-networking system 560 from a client system 530. Posts may include data such as status updates or other textual data, location information, photos, videos, links, music or other similar data or media. Content may also be added to social-networking system 560 by a third-party through a “communication channel,” such as a newsfeed or stream.

In particular embodiments, social-networking system 560 may include a variety of servers, sub-systems, programs, modules, logs, and data stores. In particular embodiments, social-networking system 560 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 560 may also include suitable components such as network interfaces, security mechanisms, load balancers, failover servers, management-and-network-operations consoles, other suitable components, or any suitable combination thereof. In particular embodiments, social-networking system 560 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 560 to one or more client systems 530 or one or more third-party system 570 via network 510. The web server may include a mail server or other messaging functionality for receiving and routing messages between social-networking system 560 and one or more client systems 530. An API-request server may allow a third-party system 570 to access information from social-networking system 560 by calling one or more APIs. An action logger may be used to receive communications from a web server about a user's actions on or off social-networking system 560. In conjunction with the action log, a third-party-content-object log may be maintained of user exposures to third-party-content objects. A notification controller may provide information regarding content objects to a client system 530. Information may be pushed to a client system 530 as notifications, or information may be pulled from client system 530 responsive to a request received from client system 530. Authorization servers may be used to enforce one or more privacy settings of the users of social-networking system 560. A privacy setting of a user determines how particular information associated with a user can be shared. The authorization server may allow users to opt in to or opt out of having their actions logged by social-networking system 560 or shared with other systems (e.g., third-party system 570), such as, for example, by setting appropriate privacy settings. Third-party-content-object stores may be used to store content objects received from third parties, such as a third-party system 570. Location stores may be used for storing location information received from client systems 530 associated with users. Advertisement-pricing modules may combine social information, the current time, location information, or other suitable information to provide relevant advertisements, in the form of notifications, to a user.

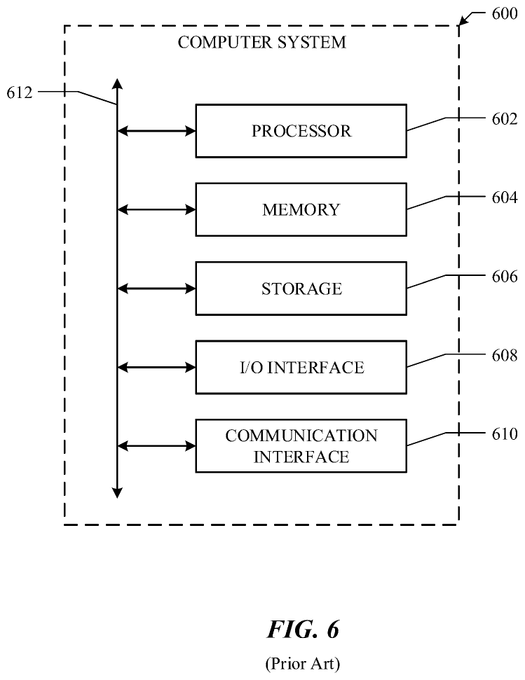

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a Wi-Fi™ network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN), a Wi-Fi™ network, a WiMAX™ network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT™ (HT) interconnect, an Industry Standard Architecture (ISA) bus, an INFINIBAND™ interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, memory cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

The claims:

1. A method, comprising:
generating, by a first computing device, a client public key and a client private key;
sending, by the first computing device, a message to a user equipment, the message comprising the client public key and a client challenge;
receiving, by the first computing device, a first response from the user equipment in response to the message, the first response comprising (a) a server public key generated by the user equipment, (b) a device certificate of the user equipment, and (c) a signature generated by the user equipment by signing the client challenge using a device private key of the user equipment, wherein the device certificate and the device private key were stored on the user equipment by a manufacturer of the user equipment;
verifying, by the first computing device, an authenticity of the user equipment by sending the device certificate to a cloud-based service associated with a certificate authority for the certificate authority to first validate a trustworthiness of the device certificate;
verifying, by the first computing device, using a device public key, that the user equipment is manufactured by the manufacturer based on the signature signed using the device private key;
generating, by the first computing device, a shared secret using the client private key and the server public key;
receiving, by the first computing device, a credential for a remote user account;
connecting, by the first computing device, to the remote user account based on the credential;
obtaining, by the first computing device, a bonding key associated with the remote user account, wherein the bonding key is generated based on information associated with the remote user account; and
sending, by the first computing device, the bonding key to the user equipment for storage by the user equipment, the bonding key being sent through a secure connection established using the shared secret;
wherein a first proof of possession of the bonding key is required for a second computing device requesting a subsequent connection with the user equipment, wherein the bonding key possessed by the second computing device is generated via the second computing device obtaining the information associated with the remote user account.

2. The method of claim 1, further comprising:
sending, by the first computing device, a second subsequent connection request to the user equipment after the sending of the bonding key;
sending, by the first computing device, a second proof of possession of the bonding key to the user equipment, the second proof of possession of the bonding key being configured to be validated by the user equipment using the bonding key stored by the user equipment;
receiving, by the first computing device, a second validation that the user equipment validated the second proof of possession of the bonding key; and
establishing, by the first computing device, a second subsequent connection with the user equipment after the second validation is received.

3. The method of claim 2, further comprising:
receiving, by the first computing device, an authentication challenge generated by the user equipment in response to the second subsequent connection request; and
generating, by the first computing device, the second proof of possession of the bonding key based on the received authentication challenge and the bonding key.

4. The method of claim 1, further comprising:
sending, by the first computing device, a second subsequent connection request to the user equipment after the sending of the bonding key;
connecting, by the first computing device, to a second remote user account based on a second credential;
obtaining, by the first computing device, a second bonding key based on information associated with the second remote user account;
sending, by the first computing device, a proof of possession of the second bonding key to the user equipment; and
receiving, by the first computing device, a rejection of the second subsequent connection request from the user equipment.

5. The method of claim 1, further comprising:
after the authenticity of the user equipment is verified, storing, by the first computing device, the device certificate for establishing one or more second subsequent connections with the user equipment.

6. (canceled)

7. (canceled)

8. The method of claim 5, further comprising:
sending, by the first computing device, a second connection request to the user equipment after the sending of the bonding key, the second connection request including a fingerprint of the stored device certificate;
receiving, by the first computing device, a second response to the second connection request from the user equipment; and
determining, by the first computing device, that the stored device certificate remains valid based on a determination that the second response lacks a new device certificate.

9. The method of claim 8, wherein the first response uses more communication packets than the second response.

10. (canceled)

11. One or more computer-readable non-transitory storage media embodying software that is operable when executed by a first computing device to:
generate a client public key and a client private key;
send a message to a user equipment, the message comprising the client public key and a client challenge;
receive a first response from the user equipment in response to the message, the first response comprising (a) a server public key generated by the user equipment, (b) a device certificate of the user equipment, and (c) a signature generated by the user equipment by signing the client challenge using a device private key of the user equipment, wherein the device certificate and the device private key were stored on the user equipment by a manufacturer of the user equipment;
verify an authenticity of the user equipment by sending the device certificate to a cloud-based service associated with a certificate authority for the certificate authority to first validate a trustworthiness of the device certificate;
verify that the user equipment is manufactured by the manufacturer based on the signature signed using the device private key by using a device public key;
generate a shared secret using the client private key and the server public key;
receive a credential for a remote user account;
connect to the remote user account based on the credential;
obtain a bonding key associated with the remote user account, wherein the bonding key is generated based on information associated with the remote user account; and
send the bonding key to the user equipment for storage by the user equipment, the bonding key being sent through a secure connection established using the shared secret;
wherein a first proof of possession of the bonding key is required for a second computing device requesting a subsequent connection with the user equipment, wherein the bonding key possessed by the second computing device is generated via the second computing device obtaining the information associated with the remote user account.

12. The media of claim 11, wherein the software is further operable when executed to:
send a second subsequent connection request to the user equipment after the sending of the bonding key;
send a second proof of possession of the bonding key to the user equipment, the second proof of possession of the bonding key being configured to be validated by the user equipment using the bonding key stored by the user equipment;
receive a second validation that the user equipment validated the second proof of possession of the bonding key; and
establish a second subsequent connection with the user equipment after the second validation is received.

13. The media of claim 12, wherein the software is further operable when executed to:
receive an authentication challenge generated by the user equipment in response to the second subsequent connection request; and
generate the second proof of possession of the bonding key based on the received authentication challenge and the bonding key.

14. The media of claim 11, wherein the software is further operable when executed to:
send a second subsequent connection request to the user equipment after the sending of the bonding key;
connect to a second remote user account based on a second credential;
obtain a second bonding key based on information associated with the second remote user account;
send a proof of possession of the second bonding key to the user equipment; and
receive a rejection of the second subsequent connection request from the user equipment.

15. The media of claim 11, wherein the software is further operable when executed to:
after the authenticity of the user equipment is verified, store the device certificate for establishing one or more second subsequent connections with the user equipment.

16. A system comprising: a first computing device comprising one or more processors; and one or more computer-readable non-transitory storage media coupled to one or more of the processors and comprising instructions operable when executed by one or more of the processors to cause the system to:
generate a client public key and a client private key;
send a message to a user equipment, the message comprising the client public key and a client challenge;
receive a first response from the user equipment in response to the message, the first response comprising (a) a server public key generated by the user equipment, (b) a device certificate of the user equipment, and (c) a signature generated by the user equipment by signing the client challenge using a device private key of the user equipment, wherein the device certificate and the device private key were stored on the user equipment by a manufacturer of the user equipment;
verify an authenticity of the user equipment by sending the device certificate to a cloud-based service associated with a certificate authority for the certificate authority to first validate a trustworthiness of the device certificate;
verify that the user equipment is manufactured by the manufacturer based on the signature signed using the device private key by using a device public key;
generate a shared secret using the client private key and the server public key;
receive a credential for a remote user account;
connect to the remote user account based on the credential;
obtain a bonding key associated with the remote user account; and
send the bonding key to the user equipment for storage by the user equipment, the bonding key being sent through a secure connection established using the shared secret;
wherein a first proof of possession of the bonding key is required for a second computing device requesting a subsequent connection with the user equipment, wherein the bonding key possessed by the second computing device is generated via the second computing device obtaining the information associated with the remote user account.

17. The system of claim 16, wherein the processors are further operable when executing the instructions to:
send a second subsequent connection request to the user equipment after the sending of the bonding key;
send a second proof of possession of the bonding key to the user equipment, the second proof of possession of the bonding key being configured to be validated by the user equipment using the bonding key stored by the user equipment;
receive a second validation that the user equipment validated the second proof of possession of the bonding key; and
establish a second subsequent connection with the user equipment after the second validation is received.

18. The system of claim 17, wherein the processors are further operable when executing the instructions to:
receive an authentication challenge generated by the user equipment in response to the second subsequent connection request; and
generate the second proof of possession of the bonding key based on the received authentication challenge and the bonding key.

19. The system of claim 16, wherein the processors are further operable when executing the instructions to:
send a second subsequent connection request to the user equipment after the sending of the bonding key;
connect to a second remote user account based on a second credential;
obtain a second bonding key based on information associated with the second remote user account;
send a proof of possession of the second bonding key to the user equipment; and
receive a rejection of the second subsequent connection request from the user equipment.

20. The system of claim 16, wherein the processors are further operable when executing the instructions to:
after the authenticity of the user equipment is verified, store the device certificate for establishing one or more second subsequent connections with the user equipment.
